(19) United States
(12) Patent Application Publication
(10) Pub. No.: US 2020/0229243 A1
(43) Pub. Date: Jul. 16, 2020

(54) RANDOM ACCESS CONTROL METHOD AND DEVICE

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd.

(21) Appl. No.: 16/829,202

(22) Filed: Mar. 25, 2020

Related U.S. Application Data
(63) Continuation of application No. PCT/CN2017/104638, filed on Sep. 29, 2017.

(51) Int. Cl. H04W 74/08; H04W 24/08; H04W 52/36; H04W 72/04

(52) U.S. Cl. CPC H04W 74/0833; H04W 72/046; H04W 52/367; H04W 24/08

(57) ABSTRACT

A random access control method, includes: determining whether a random access response is received from a base station; if not, determining whether a first count value is equal to a first preset value; if yes, determining whether a time window monitoring the reception of the random access response and corresponding to the preset time window has ended; if so, sending a preamble to the base station at a preamble transmission opportunity within a next preset time window and increasing the first count value, and if not, sending the preamble to the base station at a next preamble transmission opportunity and increasing the first count value; and repeating above steps, and until the first count value is equal to the first preset value or the random access response from is received the base station, and stopping sending the preamble to the base station.

### CROSS-REFERENCE TO RELATED APPLICATION

This application is a continuation of International Application No. PCT/CN2017/104638 filed on Sep. 29, 2017, the content of which is incorporated herein by reference in its entirety.

### TECHNICAL FIELD

The present disclosure generally relates to the technical field of terminals, and more particularly, to a random access control method, a random access control device, an electronic device and a non-transitory computer-readable storage medium.

### BACKGROUND

In a Long Term Evolution (LTE) (i.e., 4th-Generation (4G)) system, a base station broadcasts a message through a beam in the whole region where the base station is located. User equipment (UE) initiating random access to the base station is only required to send a beam once to a direction, and the base station can receive the beam. Under this circumstance, the UE, if failing in random access, can count a count value on which random access is re-initiated based according to an existing counting manner.

However, in a New Radio (NR) (i.e., 5th-Generation (5G)) system, the base station covers a region where the base station is located in a beam scanning manner, namely the base station only sends a narrow beam to a certain direction at a certain moment and then constantly changes the direction of the narrow beam to cover a corresponding sector. Certain UE, when initiating random access to the base station, is required to send beams to multiple directions respectively, so as to ensure that the base station can receive the beams in a scanning manner. Under this circumstance, if UE fails in random access, there is no appropriate counting manner for a count value on which random access is re-initiated based.

### SUMMARY

According to a first aspect of embodiments of the present disclosure, a random access control method includes: sending a preamble to a base station at a preamble transmission opportunity within a preset time window and increasing a first count value, wherein the preset time window includes multiple preamble transmission opportunities; determining whether a random access response (RAR) is received from the base station; when the RAR is not received from the base station, determining whether the first count value is equal to a first preset value; when the first count value is not equal to the first preset value, determining whether a time window monitoring reception of the RAR and corresponding to the preset time window ends; when the time window monitoring reception of the RAR and corresponding to the preset time window ends, sending the preamble to the base station at a preamble transmission opportunity within a next preset time window and increasing the first count value; when the time window monitoring reception of the RAR and corresponding to the preset time window does not end, sending the preamble to the base station at a next preamble transmission opportunity and increasing the first count value; and repeating above steps and, when the first count value is equal to the first preset value or the RAR is received from the base station, stopping sending the preamble to the base station.

According to a second aspect of embodiments of the present disclosure, a random access control method includes: sending a preamble to a base station at a preamble transmission opportunity within a preset time window, wherein the preset time window includes multiple preamble transmission opportunities; determining whether an RAR is received from the base station; when the RAR is not received from the base station, determining whether a first count value is equal to a first preset value; when the first count value is not equal to the first preset value, determining whether a time window monitoring reception of the RAR and corresponding to the preset time window ends; when the time window monitoring reception of the RAR and corresponding to the preset time window ends, sending the preamble to the base station at a preamble transmission opportunity within a next preset time window and increasing the first count value; when the time window monitoring reception of the RAR and corresponding to the preset time window does not end, sending the preamble to the base station at a next preamble transmission opportunity and increasing the first count value; and repeating above steps and, until the first count value is equal to the first preset value or the RAR is received from the base station, stopping sending the preamble to the base station.

According to a third aspect of embodiments of the present disclosure, an electronic device includes: a processor; and a memory configured to store instructions executable by the processor, wherein the processor is configured to: send a preamble to a base station at a preamble transmission opportunity within a preset time window and increase a first count value, wherein the preset time window includes multiple preamble transmission opportunities; determine whether an RAR is received from the base station; when the RAR is not received from the base station, determine whether the first count value is equal to a first preset value; when the first count value is not equal to the first preset value, determine whether a time window monitoring reception of the RAR and corresponding to the preset time window ends; when the time window monitoring reception of the RAR and corresponding to the preset time window ends, send the preamble to the base station at a preamble transmission opportunity within a next preset time window and increase the first count value; when the time window monitoring reception of the RAR and corresponding to the preset time window does not end, send the preamble to the base station at a next preamble transmission opportunity and increase the first count value; and repeat above steps and, until the first count value is equal to the first preset value or the RAR is received from the base station, stop sending the preamble to the base station.

According to a fourth aspect of embodiments of the present disclosure, an electronic device includes: a processor; and a memory configured to store instructions executable by the processor, wherein the processor is configured to perform the random access control method of the second aspect.

It is to be understood that the above general description and detailed description below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a random access control method, according to an exemplary embodiment.

FIG. 2 is a flow chart showing a random access control method, according to an exemplary embodiment.

FIG. 3 is a flow chart showing a random access control method, according to an exemplary embodiment.

FIG. 4 is a flow chart showing a method for determining whether preamble transmission power needs to be adjusted, according to an exemplary embodiment.

FIG. 5 is a flow chart showing a method for determining whether preamble transmission power needs to be adjusted, according to an exemplary embodiment.

FIG. 6 is a flow chart showing a random access control method, according to an exemplary embodiment.

FIG. 7 is a block diagram of a random access control device, according to an exemplary embodiment.

FIG. 8 is a block diagram of a random access control device, according to an exemplary embodiment.

FIG. 9 is a block diagram of a random access control device, according to an exemplary embodiment.

FIG. 10 is a block diagram of a regulation determination module, according to an exemplary embodiment.

FIG. 11 is a block diagram of a regulation determination module, according to an exemplary embodiment.

FIG. 12 is a block diagram of a regulation determination module, according to an exemplary embodiment.

FIG. 13 is a block diagram of a random access control device, according to an exemplary embodiment.

FIG. 14 is a block diagram of a random access control device, according to an exemplary embodiment.

FIG. 15 is a block diagram of a random access control device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

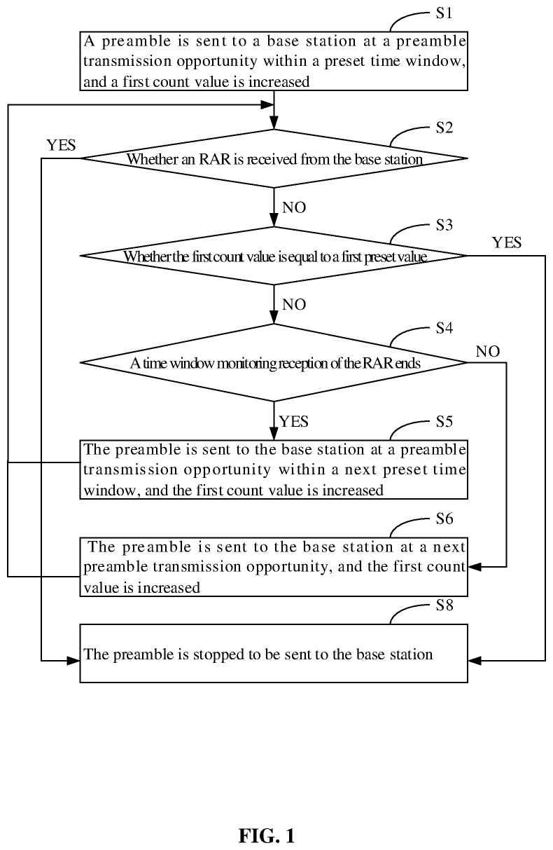

FIG. 1 is a flow chart showing a random access control method, according to an exemplary embodiment. The random access control method can be applied to user equipment (UE), for example, a mobile phone, a tablet computer and the like. As illustrated in FIG. 1, the random access control method can include the following steps.

In step S1, a preamble is sent to a base station at a preamble transmission opportunity within a preset time window, and a first count value is increased. The preset time window may include multiple preamble transmission opportunities.

In step S2, it is determined whether a random access response (RAR) is received from the base station. If the RAR is not received from the base station, step S3 is executed, and if the RAR is received from the base station, step S8 is executed.

In step S3, it is determined whether the first count value is equal to a first preset value. If the first count value is not equal to the first preset value, step S4 is executed, and if the first count value is equal to the first preset value, step S8 is executed.

In step S4, it is determined whether a time window monitoring reception of the RAR and corresponding to the preset time window ends. If the time window ends, step S5 is executed, and if the time window does not end, step S6 is executed.

In step S5, the preamble is sent to the base station at a preamble transmission opportunity within a next preset time window, and the first count value is increased.

In step S6, the preamble is sent to the base station at a next preamble transmission opportunity, and the first count value is increased.

The steps are cyclically executed, and when the first count value is equal to the first preset value or the RAR is received from the base station, step S8 is executed.

In step S8, the preamble is stopped to be sent to the base station.

In an embodiment, the UE may send a preamble to the base station for multiple times.

For example, in an NR (i.e., 5G) system, if the UE does not have Tx-Rx correspondence, the UE may not determine a most appropriate direction for preamble sending to the base station through beams according to a received signal broadcast by the base station. Under this circumstance, the UE may try to send a preamble through multiple beams (directions of the beams are different) to determine the most appropriate direction for preamble sending to the base station through the beams according to a response to the sent preamble from base station.

For example, under the circumstance that signal strength for communication between the base station and the UE is relatively low (for example, the signal strength is less than a preset decibel), even though the UE determines the most appropriate direction for preamble sending to the base station through beams, the UE may also need to send the preamble to the base station through beams in the determined direction for multiple times during random access of each time, so as to ensure that the base station can receive the preamble under the circumstance of relatively low signal strength.

Besides the above two circumstances, the method in the embodiment is also applied to other circumstances where the UE needs to send the preamble to the base station for multiple times. The following exemplary embodiments are mainly based on the first circumstance.

In an embodiment, every time when the UE sends the preamble to the base station, whether random access to the base station succeeds can be determined. If the UE determines that random access to the base station fails, the preamble can be resent to the base station to try random access to the base station. The circumstance that the UE sends the preamble to the base station can be statistically managed to avoid resource consumption of the UE and the base station, caused by continuous preamble resending to the base station when the UE determines that access to the base station fails.

In an embodiment, the number of times for which the preamble is sent for multiple times can be preset. For example, the UE needs to try to send the preamble through multiple beams (directions of the beams are different). The time window monitoring reception of the RAR starts for monitoring after a first transmission opportunity in the preset time window. The time window monitoring reception of the RAR corresponds to the preset time window one to one.

In an embodiment, the first count value can be a count value of a preamble transmission counter (PREAMBLE_TRANSMISSION_COUNTER). Every time when the preamble is sent, the first count value can be increased, for example, by 1 (a specific increment of the first count value can be set as required). It can be determined whether the first count value reaches a preset upper limit (i.e., the first preset value), and under the circumstance that the first count value reaches the set upper limit, the preamble is stopped to be sent to the base station. Therefore, the resource consumption of the UE and the base station, caused by continuous preamble resending to the base station when the UE determines that access to the base station fails, is avoided.

If the RAR is not received from the base station and the first count value is not equal to the first preset value (specifically, the first count value is less than the first preset value), the preamble can be continued to be sent to the base station to request random access. However, under the circumstance that the UE needs to try to send the preamble through multiple beams, if the time window monitoring reception of the RAR has ended, it is indicated that the UE has completed sending the preamble within a preset time window; and if it is needed to continue sending the preamble, the preamble is sent at a preamble transmission opportunity within a next preset time window.

If the RAR sent to the UE by the base station is an RAR to the preamble sent by the UE, an identifier in the RAR is identical with an identifier of the preamble sent by the UE (for example, an identifier of a resource block or synchronization block occupied by the preamble) or is identical with an identifier of the preset time window where the preamble sent by the UE (for example, an identifier of a resource block or synchronization block occupied by the preset time window) is located. Therefore, the UE, once receiving an RAR to a certain preamble in the preset time window from the base station, can determine that the RAR to the preamble sent in the preset time window has been successfully received and stop sending the preamble in the preset time window.

Accordingly, preamble transmission of each round can be distinguished to conveniently record the preamble transmission rounds (i.e., the number of preset time windows that are occupied), and a parameter such as preamble transmission power in different preset time windows can be adjusted.

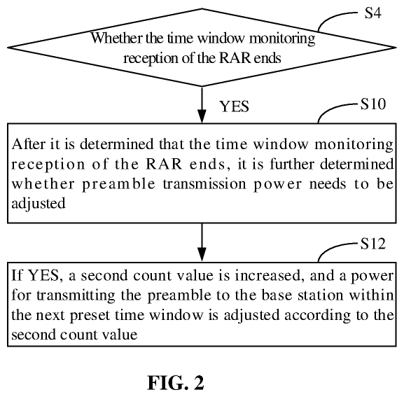

FIG. 2 is a flow chart showing a random access control method, according to an exemplary embodiment. Based on the embodiment illustrated in FIG. 1, the random access control method in FIG. 2 further includes the following steps (for convenience of description, some steps in the embodiment illustrated in FIG. 1 are omitted).

In step S10, after it is determined that the time window monitoring reception of the RAR and corresponding to the preset time window ends, it is further determined whether preamble transmission power needs to be adjusted; if YES, step S12 is executed.

In step S12, a second count value is increased, and a power for sending the preamble to the base station within a next preset time window is adjusted according to the second count value.

In an embodiment, the second count value can be a count value of a preamble power ramping counter (PREAMBLE_POWER_RAMPING_COUNTER). Based on the embodiment illustrated in FIG. 1, if the time window monitoring reception of the RAR ends, the UE can send the preamble at the preamble transmission opportunity within the next preset time window. The preamble transmission rounds (i.e., the number of the preset time windows that are occupied) can be recorded according to the second count value.

In an embodiment, if the second count value is increased, for example, by 1, it can be determined that the preamble is to be sent next time at the preamble transmission opportunity within the next preset time window. Once the preset time window changes, the preamble transmission power needs to be adjusted. Therefore, if it is determined that the preamble transmission power needs be adjusted, the power for sending the preamble to the base station at the next preamble transmission opportunity can be adjusted according to the second count value.

For example, if the UE does not receive the RAR sent by the base station but has ended monitoring within a preset time window, it can be because power P1 for sending the preamble in the preset time window is relatively low, so that the power for sending the preamble to the base station within the next preset time window can be adjusted according to the second count value. For example, if the second count value is increased by 1, it can be determined that P1 needs to be increased by a power step length P0 to obtain the power P2 for sending the preamble to the base station within the next preset time window, namely P2=P1+P0; and if the second count value is increased by 2, namely P2=P1+2P0, and so on. A specific increment of the second count value can be set as required.

Accordingly, the preamble transmission power can be adjusted according to the second count value to meet a corresponding requirement every time when it is needed to send the preamble at the preamble transmission opportunity within the next preset time window. It may be ensured that the preamble sent by the UE within the next preset time window is received by the base station more easily, and a probability that random access succeeds is improved.

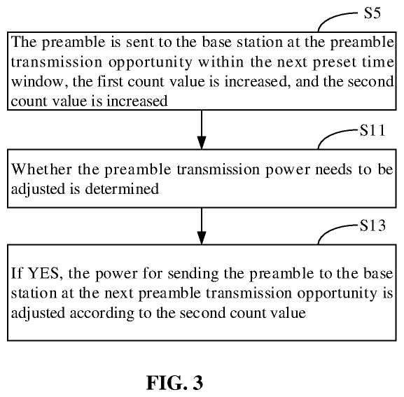

FIG. 3 is a flow chart showing a random access control method, according to an exemplary embodiment. Based on the embodiment illustrated in FIG. 1, the random access control method in FIG. 3 further includes the following steps (for convenience of description, some steps in the embodiment illustrated in FIG. 1 are omitted).

After the first count value is increased, the second count value is increased in step S5, step S11 is executed.

In step S11, it is determined whether the preamble transmission power needs to be adjusted; if YES, step S13 is executed.

In step S13, the power for sending the preamble to the base station at the next preamble transmission opportunity is adjusted according to the second count value.

In an embodiment, the second count value can be increased along with the increase of the first count value.

Under this circumstance, the preamble transmission power is adjusted according to the second count value. Therefore, the preamble transmission power can be adjusted according to the second count value to meet the corresponding requirement every time when it is needed to send the preamble at the next preamble transmission opportunity. It may be ensured that the preamble sent by the UE at the next preamble transmission opportunity is received by the base station more easily, and the probability that random access succeeds is improved.

In an embodiment, in the embodiments illustrated in FIG. 2 and FIG. 3, information for determining whether the preamble transmission power needs be adjusted can be sent to a media access control layer through a physical layer of the UE. For example, in the embodiment illustrated in FIG. 2, the physical layer, after sending a preamble and before the next preset time window, can indicate whether the preamble transmission power needs to be adjusted to the media access control layer. In the embodiment illustrated in FIG. 3, the physical layer, every time when sending a preamble, can indicate whether the preamble transmission power needs to be adjusted to the media access control layer.

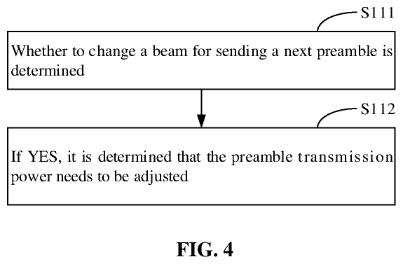

FIG. 4 is a flow chart showing a method for determining whether preamble transmission power needs to be adjusted, according to an exemplary embodiment. Based on the embodiment illustrated in FIG. 3, the method in FIG. 4 for determining whether the preamble transmission power needs to be adjusted includes the following steps.

In step S111, it is determined whether to change a beam for sending a next preamble.

In step S112, if YES, it is determined that the preamble transmission power needs to be adjusted.

In an embodiment, if the beam needs to be changed for sending the next preamble, it can be determined that the preamble transmission power needs to be adjusted. For example, under the circumstance that the UE needs to try to send the preamble through multiple beams, if the UE determines that the beam needs to be changed for sending the next preamble, it can be determined that the preamble transmission power needs to be adjusted, so that the second count value is increased and the power for sending the next preamble is further increased, so as to ensure that the next preamble to be sent is received by the base station more easily and improve the probability that random access succeeds.

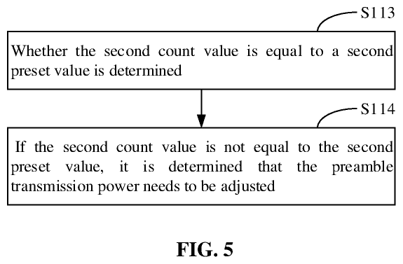

FIG. 5 is a flow chart showing a method for determining whether preamble transmission power needs to be adjusted, according to an exemplary embodiment. Based on the embodiment illustrated in FIG. 2 or FIG. 3, the method in FIG. 5 for determining whether the preamble transmission power needs to be adjusted includes the following steps.

In step S113, it is determined whether the second count value is equal to a second preset value.

In step S114, if the second count value is not equal to the second preset value, it is determined that the preamble transmission power needs to be adjusted.

In an embodiment, an upper limit value (for example, the second preset value) can be set for the second count value; and if the second count value is not equal to (specifically less than) the second preset value, it is determined that the second count value can be continued to be increased.

In an embodiment, the first count value is a count value of the preamble transmission counter, and the second count value is a count value of the preamble power ramping counter.

In an embodiment, the UE can be controlled to stop sending the preamble according to the count value of the preamble transmission counter to avoid the resource consumption of the UE and the base station, caused by continuous preamble transmission to the base station when the UE determines that access to the base station fails. The preamble transmission power of the UE can be adjusted according to the count value of the preamble power ramping counter to improve a probability that the preamble is received by the base station and further improve the probability that random access succeeds.

In an embodiment, sending the preamble to the base station at the preamble transmission opportunity in the preset time window includes: sending the preamble at a first preamble transmission opportunity within each preset time window through first beams of different directions.

In an embodiment, the UE sending the preamble to the base station at the preamble transmission opportunity in the preset time window can include: sending the preamble at multiple preamble transmission opportunities through beams of multiple directions respectively to determine a most appropriate direction for preamble transmission to the base station through the beams (for example, in this direction, strength of a signal fed back by the base station is highest).

In an embodiment, sending the preamble to the base station at the preamble transmission opportunity in the preset time window includes: sending the preamble at each preamble transmission opportunity in the preset time window through beams of the same direction.

In an embodiment, the UE sending the preamble to the base station at the preamble transmission opportunity in the preset time window can include: sending the preamble in the same direction at multiple preamble transmission opportunities to enable the base station to receive the preamble sent by the UE under the circumstance of relatively low signal strength for communication between the base station and the UE.

In an embodiment, the preamble sent to the base station at the preamble transmission opportunity in the preset time window and the preamble sent to the base station at the preamble transmission opportunity within the next preset time window are identical.

In an embodiment, the media access control layer of the UE can specify a preamble, or the base station can configure the preamble for the UE, so that the preambles sent to the base station by the UE every time are identical.

In an embodiment, the preamble sent to the base station at the preamble transmission opportunity in the preset time window and the preamble sent to the base station at the preamble transmission opportunity within the next preset time window are different preambles in a set of preambles.

In an embodiment, the media access control layer of the UE can specify a preamble set, or the base station can configure the preamble set for the UE, and the preamble set includes multiple preambles, so that the UE can send any preamble of the multiple preambles to the base station at multiple preamble transmission opportunities within a preset time window. The preambles sent at each preamble transmission opportunity can be identical or different; if they are different, the multiple preambles can be sent one by one at the multiple preamble transmission opportunities.

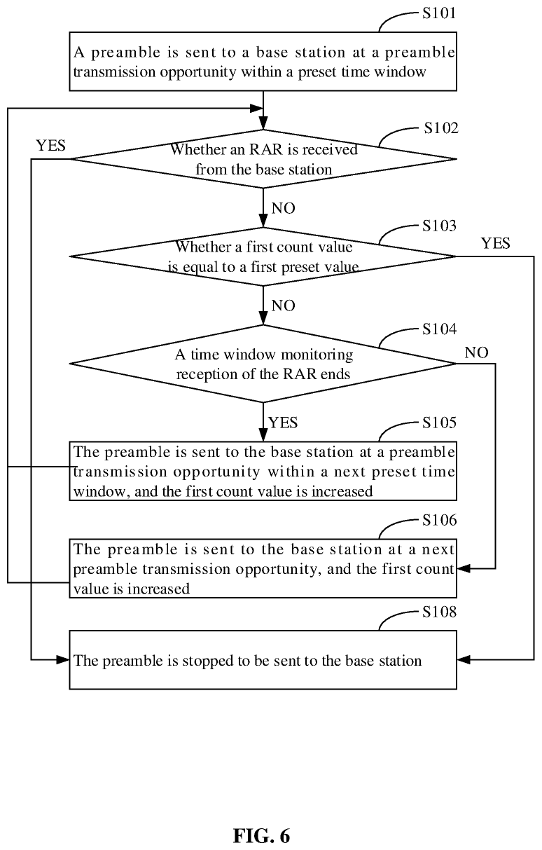

FIG. 6 is a flow chart showing a random access control method, according to an exemplary embodiment. The random access control method can be applied to UE, for example, a mobile phone, a tablet computer and the like. As illustrated in FIG. 6, the random access control method can include the following steps.

In step S101, a preamble is sent to a base station at a preamble transmission opportunity within a preset time window, and the preset time window includes multiple preamble transmission opportunities.

In step S102, it is determined whether an RAR is received from the base station; if the RAR is not received from the base station, step S103 is executed, and if the RAR is received from the base station, step S108 is executed.

In step S103, it is determined whether a first count value is equal to a first preset value; if the first count value is not equal to the first preset value, step S104 is executed, and if the first count value is equal to the first preset value, step S108 is executed.

In step S104, it is determined whether a time window monitoring reception of the RAR and corresponding to the preset time window ends; if YES, step S105 is executed, and if NO, step S106 is executed.

In step S105, the preamble is sent to the base station at a preamble transmission opportunity within a next preset time window, and the first count value is increased.

In step S106, the preamble is sent to the base station at a next preamble transmission opportunity, and the first count value is increased.

The steps are cyclically executed, and when the first count value is equal to the first preset value or the RAR is received from the base station, step S108 is executed.

In step S108, the preamble is stopped to be sent to the base station.

For example, a difference between this embodiment and the embodiment illustrated in FIG. 1 is that the first count value is increased (for example, by 1) only when the preamble is sent to the base station at the preamble transmission opportunity within the next preset time window. The first count value can be a count value of a preamble transmission counter (PREAMBLE_TRANSMISSION_COUNTER). That is, in this embodiment, the first count value is configured to indicate a specific preset time window where the preamble to be sent is located.

According to the embodiment, it can be determined whether the first count value reaches a set upper limit (i.e., the first preset value, the first preset value here can be different from the first preset value in the embodiment illustrated in FIG. 1), and under the circumstance that the first count value reaches the set upper limit, the preamble is stopped to be sent to the base station, thereby avoiding resource consumption of the UE and the base station, caused by continuous preamble resending to the base station when UE determines that random access to the base station fails.

In an embodiment, the base station can include a random access radio network temporary identifier (RA-RNTI) in the RAR as an identifier associated with the RAR, which indicates whether the RAR is an RAR to the preamble sent by the UE.

In an embodiment, the random access control method further includes: it is determined that the time window monitoring the RAR and reception of the RAR and corresponding to the preset time window ends, and a second count value is increased; it is determined whether preamble transmission power needs to be adjusted; and if YES, a power for sending the preamble to the base station within the next preset time window is adjusted according to the second count value.

In an embodiment, the second count value can be a count value of a preamble power ramping counter (PREAMBLE_POWER_RAMPING_COUNTER). Based on the embodiment illustrated in FIG. 1, if it is determined that the time window monitoring the RAR and reception of the RAR and corresponding to the preset time window ends, the UE can transmit the preamble at the preamble transmission opportunity within the next preset time window. Preamble transmission rounds (i.e., the number of preset time windows that are occupied) can be recorded according to the second count value.

In an embodiment, if the second count value is increased, for example, by 1, it can be determined that the preamble is to be sent next time at the preamble transmission opportunity within the next preset time window. Once the preset time window changes, the preamble transmission power can be required to be adjusted. Therefore, if it is determined that the preamble transmission power needs to be adjusted, the power for sending the preamble to the base station at the next preamble transmission opportunity can be adjusted according to the second count value.

For example, if the UE does not receive the RAR sent by the base station but the time window monitoring reception of the RAR has ended, it can be because power P1 for sending the preamble in the preset time window is relatively low, so that the power for sending the preamble to the base station within the next preset time window can be adjusted according to the second count value. For example, if the second count value is increased by 1, it can be determined that P1 needs to be increased by a power step length P0 to obtain the power P2 for sending the preamble to the base station within the next preset time window, namely P2=P1+P0; and if the second count value is increased by 2, namely P2=P1+2P0, and so on. A specific increment of the second count value can be set as required.

Accordingly, the preamble transmission power can be adjusted according to the second count value to meet a corresponding requirement every time when it is necessary to send the preamble at the preamble transmission opportunity within the next preset time window. For example, it is ensured that the preamble sent by the UE within the next preset time window is received by the base station more easily, and a probability that random access succeeds is improved.

In an embodiment, determining whether the preamble transmission power needs to be adjusted includes: determining whether the second count value is equal to a second preset value; and if the second count value is not equal to the second preset value, determining that the preamble transmission power needs to be adjusted.

In an embodiment, an upper limit value (for example, the second preset value) can be set for the second count value; and if the second count value is not equal to (specifically less than) the second preset value, it is determined that the second count value can be continued to be increased.

In an embodiment, determining whether the preamble transmission power needs to be adjusted includes: determining whether the preamble transmission power can be adjusted according to pre-stored information; and if it is determined that the preamble transmission power can be adjusted, determining that the preamble transmission power needs to be adjusted.

In an embodiment, the base station and the UE can predetermine whether the preamble transmission power can be adjusted, a predetermined content can be stored in the pre-stored information, and the UE can read the pre-stored information to determine whether the preamble transmission power can be adjusted.

In an embodiment, the first count value is a count value of the preamble transmission counter.

In an embodiment, the UE can be controlled to stop sending the preamble according to the count value of the preamble transmission counter to avoid the resource consumption of the UE and the base station, caused by continuous preamble resending to the base station when the UE determines that access to the base station fails.

In an embodiment, sending the preamble to the base station at the preamble transmission opportunity in the preset time window includes: sending the preamble at a first preamble transmission opportunity within each preset time window through first beams of different directions. In an embodiment, the UE sending the preamble to the base station at the preamble transmission opportunity in the preset time window can include: sending the preamble at multiple preamble transmission opportunities through beams of multiple directions respectively to determine a most appropriate direction for preamble sending to the base station through the beams (for example, in this direction, strength of a signal fed back by the base station is highest).

In an embodiment, sending the preamble to the base station at the preamble transmission opportunity in the preset time window includes: sending the preamble at each preamble transmission opportunity in the preset time window through beams of the same direction.

In an embodiment, the UE sending the preamble to the base station at the preamble transmission opportunity in the preset time window can include: sending the preamble in the same direction at multiple preamble transmission opportunities to enable the base station to receive the preamble sent by the UE under the circumstance of relatively low signal strength for communication between the base station and the UE.

In an embodiment, the preamble sent to the base station at the preamble transmission opportunity in the preset time window and the preamble sent to the base station at the preamble transmission opportunity within the next preset time window are identical.

In an embodiment, the media access control layer of the UE can specify a preamble, or the base station can configure the preamble for the UE, so that the preambles sent to the base station by the UE every time are the same preamble.

In an embodiment, the preamble sent to the base station at the preamble transmission opportunity in the preset time window and the preamble sent to the base station at the preamble transmission opportunity within the next preset time window are different preambles in a set of preambles.

In an embodiment, the media access control layer of the UE can specify a preamble set, or the base station can configure the preamble set for the UE, and the preamble set includes multiple preambles, so that the UE can send any preamble in the multiple preambles to the base station at multiple preamble transmission opportunities within a preset time window. The preambles sent at each preamble transmission opportunity can be identical or different; and if they are different, the multiple preambles can be sent one by one at the multiple preamble transmission opportunities.

Corresponding to the embodiments of the random access control method, the present disclosure also provides embodiments of a random access control device.

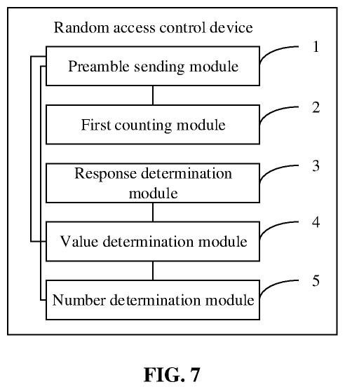

FIG. 7 is a block diagram of a random access control device, according to an exemplary embodiment. As illustrated in FIG. 7, the random access control device includes:

a preamble sending module 1, configured to send a preamble to a base station at a preamble transmission opportunity within a preset time window, the preset time window including multiple preamble transmission opportunities;

a first counting module 2, configured to, every time when the preamble sending module 1 sends the preamble to the base station, increase a first count value;

a response determination module 3, configured to determine whether an RAR is received from the base station;

a value determination module 4, configured to, under the circumstance that the response determination module 3 determines that the RAR is not received from the base station, determine whether the first count value is equal to a first preset value;

a number determination module 5, configured to, under the circumstance that the value determination module 4 determines that the first count value is not equal to the first preset value, determine whether a time window monitoring reception of the RAR and corresponding to the preset time window ends;

the preamble sending module 1 is further configured to, under the circumstance that the number determination module 5 determines that the time window monitoring reception of the RAR and corresponding to the preset time window ends, send the preamble to the base station at a preamble transmission opportunity within a next preset time window; and, under the circumstance that the number determination module 5 determines that the time window monitoring reception of the RAR and corresponding to the preset time window does not end, send the preamble to the base station at a next preamble transmission opportunity; and

the preamble sending module 1 is further configured to, under the response determination module 3 determines that the RAR is not received from the base station in the time window monitoring reception of the RAR and corresponding to the preset time window, send the preamble to the base station at the preamble transmission opportunity within the next preset time window; and, under the circumstance that the value determination module 4 determines that the first count value is equal to the first preset value or the response determination module 3 determines that the RAR is received from the base station in the time window monitoring reception of the RAR and corresponding to the preset time window, stop sending the preamble to the base station.

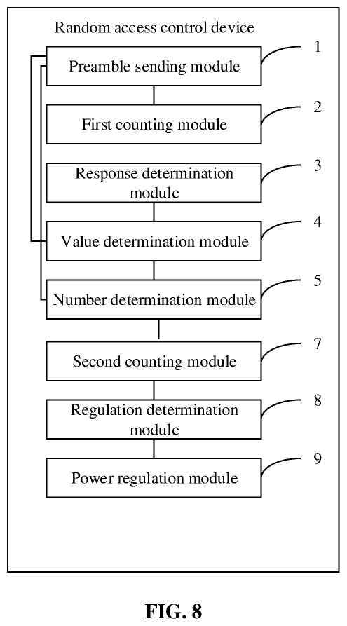

FIG. 8 is a block diagram of a random access control device, according to an exemplary embodiment. Based on the embodiment illustrated in FIG. 7, the random access control device in FIG. 8 further includes:

a second counting module 7, configured to, under the circumstance that the number determination module 5 determines that the time window monitoring reception of the RAR and corresponding to the preset time window ends, increase a second count value;

a regulation determination module 8, configured to determine whether preamble transmission power needs to be adjusted; and

a power regulation module 9, configured to, under the circumstance that the regulation determination module determines that the preamble transmission power needs to be adjusted, adjust power for sending the preamble to the base station within the next preset time window according to the second count value.

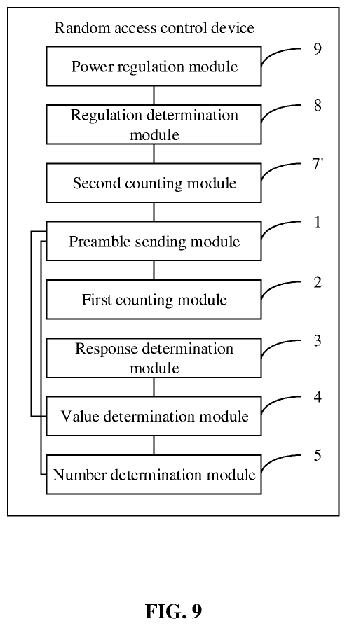

FIG. 9 is a block diagram of a random access control device, according to an exemplary embodiment. Based on the embodiment illustrated in FIG. 7, the random access control device in FIG. 9 further includes:

a second counting module 7′, configured to, when the first counting module 2 increases the first count value, increase the second count value;

the regulation determination module 8, configured to determine whether the preamble transmission power needs to be adjusted; and

the power regulation module 9, configured to, under the circumstance that the regulation determination module determines that the preamble transmission power needs to be adjusted, adjust power for sending the preamble to the base station at the next preamble transmission opportunity according to the second count value.

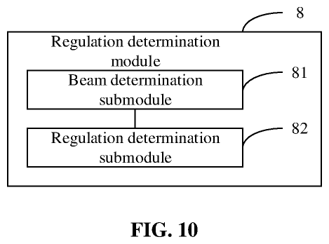

FIG. 10 is a block diagram of a regulation determination module, according to an exemplary embodiment. As illustrated in FIG. 10, based on the embodiment illustrated in FIG. 9, the regulation determination module 8 includes:

a beam determination submodule 81, configured to determine whether to change a beam for sending a next preamble; and

a regulation determination submodule 82, configured to, under the circumstance that the beam determination submodule determines to change the beam, determine that the preamble transmission power needs to be adjusted.

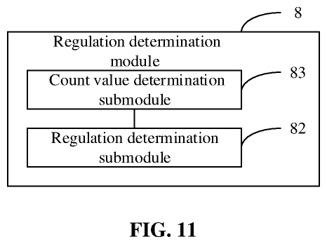

FIG. 11 is a block diagram of a regulation determination module, according to an exemplary embodiment. As illustrated in FIG. 11, based on the embodiment illustrated in FIG. 8 or FIG. 9, the regulation determination module 8 includes:

a count value determination submodule 83, configured to determine whether the second count value is equal to a second preset value; and

the regulation determination submodule 82, configured to, under the circumstance that the count value determination submodule determines that the second count value is not equal to the second preset value, determine that the preamble transmission power needs to be adjusted.

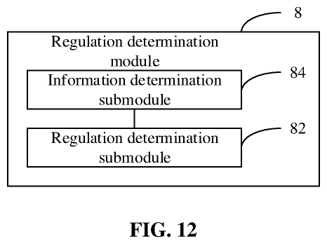

FIG. 12 is a schematic block diagram of a regulation determination module, according to an exemplary embodiment. As illustrated in FIG. 12, based on the embodiment illustrated in FIG. 8 or FIG. 9, the regulation determination module includes:

an information determination submodule 84, configured to determine whether the preamble transmission power can be adjusted according to pre-stored information; and

the regulation determination submodule 82, configured to, under the circumstance that the information determination submodule determines that the preamble transmission power can be adjusted, determine that the preamble transmission power needs to be adjusted.

In an embodiment, the first count value is a count value of a preamble transmission counter, and the second count value is a count value of a preamble power ramping counter.

In an embodiment, the preamble sending module is configured to: send the preamble at a first preamble transmission opportunity within each preset time window through first beams of different directions.

In an embodiment, the preamble sending module is configured to send the preamble at each preamble transmission opportunity in the preset time window through beams of the same direction.

In an embodiment, the preamble sent to the base station at the preamble transmission opportunity in the preset time window and the preamble sent to the base station at the preamble transmission opportunity within the next preset time window are identical.

In an embodiment, the preamble sent to the base station at the preamble transmission opportunity in the preset time window and the preamble sent to the base station at the preamble transmission opportunity within the next preset time window are different preambles in a set of preambles.

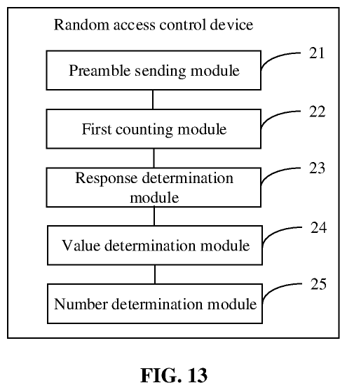

FIG. 13 is a block diagram of a random access control device, according to an exemplary embodiment. As illustrated in FIG. 13, the random access control device in the embodiment includes:

a preamble sending module 21, sending a preamble to a base station at a preamble transmission opportunity within a preset time window; the preset time window includes multiple preamble transmission opportunities;

a first counting module 22, configured to, every time when the preamble sending module 21 sends the preamble to the base station at the preamble transmission opportunity within the next preset time window, or when the preamble sending module 21 sends the preamble to the base station at a next preamble transmission opportunity, increase a first count value;

a response determination module 23, configured to determine whether an RAR is received from the base station;

a value determination module 24, configured to, under the circumstance that the response determination module 23 determines that the RAR is not received from the base station, determine whether the first count value is equal to a first preset value;

a number determination module 25, configured to, under the circumstance that the value determination module 24 determines that the first count value is not equal to the first preset value, determine whether a time window monitoring reception of the RAR and corresponding to the preset time window ends;

the preamble sending module 21 is further configured to, under the circumstance that the number determination module 25 determines that the time window monitoring reception of the RAR and corresponding to the preset time window ends, send the preamble to the base station at a preamble transmission opportunity within a next preset time window; and, under the circumstance that the number determination module 25 determines that the time window monitoring reception of the RAR and corresponding to the preset time window does not end, send the preamble to the base station at a next preamble transmission opportunity; and

the preamble sending module 21 is further configured to, under the response determination module 23 determines that the RAR is not received from the base station in the time window monitoring reception of the RAR and corresponding to the preset time window, send the preamble to the base station at the preamble transmission opportunity within the next preset time window; and, under the circumstance that the value determination module 24 determines that the first count value is equal to the first preset value or the response determination module 23 determines that the RAR is received from the base station in the time window monitoring reception of the RAR and corresponding to the preset time window , stop sending the preamble to the base station.

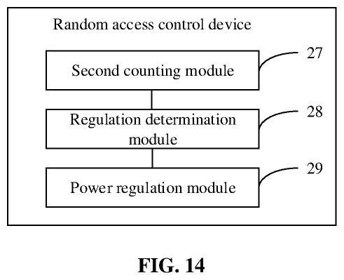

FIG. 14 is a block diagram of a random access control device, according to an exemplary embodiment. As illustrated in FIG. 14, based on the embodiment illustrated in FIG. 13, the random access control device further includes:

a second counting module 27, configured to, under the circumstance that the number determination module 25 determines that the time window monitoring reception of the RAR and corresponding to the preset time window ends, increase a second count value;

a regulation determination module 28, configured to determine whether preamble transmission power needs to be adjusted; and

a power regulation module 29, configured to, under the circumstance that the regulation determination module 28 determines that the preamble transmission power needs to be adjusted, adjust power for sending the preamble to the base station within the next preset time window according to the second count value.

In an embodiment, the first count value is a count value of a preamble transmission counter, and the second count value is a count value of a preamble power ramping counter.

With respect to the device in the above embodiment, the specific manners for performing operations for individual modules therein have been described in detail in the embodiment regarding the method, which will not be repeated herein.

The device embodiments described above are only exemplary, modules described as separate parts therein may or may not be physically separated, and parts displayed as modules may be located in the same place or may also be distributed on networks. Part or all of the modules therein can be selected according to a practical requirement.

The present disclosure also provides an electronic device, which includes: a processor; and a memory configured to store instructions executable by the processor, wherein the processor is configured to perform any one of the above random access control methods.

The present disclosure also provides a non-transitory computer-readable storage medium, in which a computer program is stored, and the program is executed by a processor to perform any one of the above random access control methods.

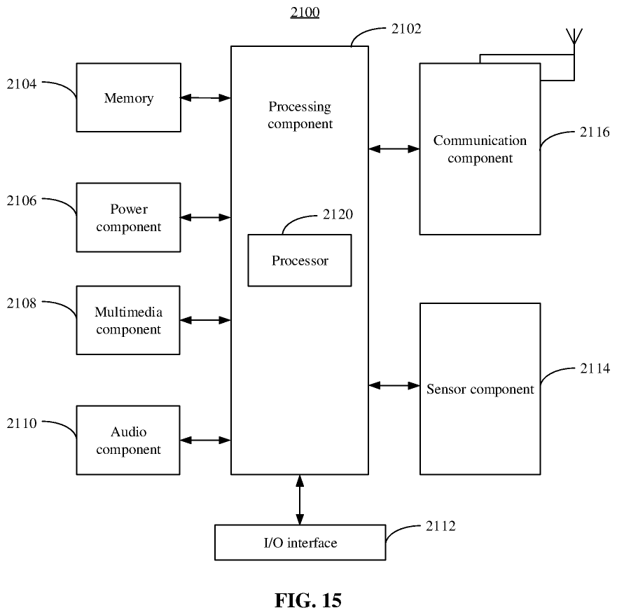

FIG. 15 is a block diagram of a random access control device 2100, according to an exemplary embodiment. For example, the device 2100 can be a mobile phone, a computer, a digital broadcast terminal, a messaging device, a gaming console, a tablet, a medical device, exercise equipment, a personal digital assistant and the like.

Referring to FIG. 15, the device 2100 can include one or more of the following components: a processing component 2102, a memory 2104, a power component 2106, a multimedia component 2108, an audio component 2110, an Input/Output (I/O) interface 2112, a sensor component 2114, and a communication component 2116.

The processing component 2102 typically controls overall operations of the device 2100, such as the operations associated with display, telephone calls, data communications, camera operations, and recording operations. The processing component 2102 can include one or more processors 2210 to execute instructions to perform all or part of the steps in the abovementioned method. Moreover, the processing component 2102 can include one or more modules which facilitate interaction between the processing component 2102 and the other components. For instance, the processing component 2102 can include a multimedia module to facilitate interaction between the multimedia component 2108 and the processing component 2102.

The memory 2104 is configured to store various types of data to support the operation of the device 2100. Examples of such data include instructions for any application programs or methods operated on the device 2100, contact data, phonebook data, messages, pictures, video, etc. The memory 2104 can be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 2106 provides power for various components of the device 2100. The power component 2106 can include a power management system, one or more power supplies, and other components associated with generation, management and distribution of power for the device 2100.

The multimedia component 2108 includes a screen providing an output interface between the device 2100 and a user. In some embodiments, the screen can include a Liquid Crystal Display (LCD) and a Touch Panel (TP). If the screen includes the TP, the screen can be implemented as a touch screen to receive an input signal from the user. The TP includes one or more touch sensors to sense touches, swipes and gestures on the TP. The touch sensors can not only sense a boundary of a touch or swipe action but also detect a duration and pressure associated with the touch or swipe action. In some embodiments, the multimedia component 2108 includes a front camera and/or a rear camera. The front camera and/or the rear camera can receive external multimedia data when the device 2100 is in an operation mode, such as a photographing mode or a video mode. Each of the front camera and the rear camera can be a fixed optical lens system or have focusing and optical zooming capabilities.

The audio component 2110 is configured to output and/or input an audio signal. For example, the audio component 2110 includes a Microphone (MIC), and the MIC is configured to receive an external audio signal when the device 2100 is in the operation mode, such as a call mode, a recording mode and a voice recognition mode. The received audio signal can further be stored in the memory 2104 or sent through the communication component 2116. In some embodiments, the audio component 2110 further includes a speaker configured to output the audio signal.

The I/O interface 2112 provides an interface between the processing component 2102 and a peripheral interface module, and the peripheral interface module can be a keyboard, a click wheel, a button and the like. The button can include, but not be limited to: a home button, a volume button, a starting button and a locking button.

The sensor component 2114 includes one or more sensors configured to provide status assessment in various aspects for the device 2100. For instance, the sensor component 2114 can detect an on/off status of the device 2100 and relative positioning of components, such as a display and small keyboard of the device 2100, and the sensor component 2114 can further detect a change in a position of the device 2100 or a component of the device 2100, presence or absence of contact between the user and the device 2100, orientation or acceleration/deceleration of the device 2100 and a change in temperature of the device 2100. The sensor component 2114 can include a proximity sensor configured to detect presence of an object nearby without any physical contact. The sensor component 2114 can also include a light sensor, such as a Complementary Metal Oxide Semiconductor (CMOS) or Charge Coupled Device (CCD) image sensor, configured for use in an imaging application. In some embodiments, the sensor component 2114 can also include an acceleration sensor, a gyroscope sensor, a magnetic sensor, a pressure sensor or a temperature sensor.

The communication component 2116 is configured to facilitate wired or wireless communication between the device 2100 and other equipment. The device 2100 can access a communication-standard-based wireless network, such as a Wireless Fidelity (WiFi) network, a 4th-Generation (4G) or 5th-Generation (5G) network or a combination thereof. In an exemplary embodiment, the communication component 2116 receives a broadcast signal or broadcast associated information from an external broadcast management system through a broadcast channel. In an exemplary embodiment, the communication component 2116 further includes a Near Field Communication (NFC) module to facilitate short-range communication. In an exemplary embodiment, the communication component 2116 can be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the device 2100 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 2104 including an instruction, and the instruction can be executed by the processor 2210 of the device 2100 to implement the abovementioned method. For example, the non-transitory computer-readable storage medium can be a ROM, a Random Access Memory (RAM), a Compact Disc Read-Only Memory (CD-ROM), a magnetic tape, a floppy disc, an optical data storage device and the like.

Other implementations of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A random access control method, comprising:
sending a preamble to a base station at a preamble transmission opportunity within a preset time window and increasing a first count value, wherein the preset time window comprises multiple preamble transmission opportunities;
determining whether a random access response (RAR) is received from the base station;
when the RAR is not received from the base station, determining whether the first count value is equal to a first preset value;
when the first count value is not equal to the first preset value, determining whether a time window monitoring reception of the RAR and corresponding to the preset time window ends;
when the time window monitoring reception of the RAR and corresponding to the preset time window ends, sending the preamble to the base station at a preamble transmission opportunity within a next preset time window, and increasing the first count value;
when the time window monitoring reception of the RAR and corresponding to the preset time window does not end, sending the preamble to the base station at a next preamble transmission opportunity, and increasing the first count value;
repeating above steps; and until the first count value is equal to the first preset value or the RAR of the base station is received, stopping sending the preamble to the base station.

2. The method of claim 1, further comprising:
when the time window monitoring reception of the RAR ends, determining whether preamble transmission power needs to be adjusted; and
when the preamble transmission power needs to be adjusted, increasing a second count value, and adjusting the preamble transmission power for sending the preamble to the base station within the next preset time window according to the second count value.

3. The method of claim 1, further comprising:
determining whether preamble transmission power needs to be adjusted; and
when the preamble transmission power needs to be adjusted, increasing a second count value when the first count value is increased, and adjusting the preamble transmission power for sending the preamble to the base station at the next preamble transmission opportunity according to the second count value.

4. The method of claim 3, wherein the determining whether the preamble transmission power needs to be adjusted comprises:
determining whether to change a beam for sending a next preamble; and
when it is determined to change the beam for sending the next preamble, determining that the preamble transmission power needs to be adjusted.

5. The method of claim 3, wherein the determining whether the preamble transmission power needs to be adjusted comprises:
determining whether the second count value is equal to a second preset value; and
when the second count value is not equal to the second preset value, determining that the preamble transmission power needs to be adjusted.

6. The method of claim 1, wherein the sending the preamble to the base station at the preamble transmission opportunity within the preset time window comprises one of:
sending the preamble at a first preamble transmission opportunity within each preset time window through first beams of different directions; or
sending the preamble at each preamble transmission opportunity within the preset time window through beams of a same direction.

7. The method of claim 1, wherein the preamble sent to the base station at the preamble transmission opportunity within the preset time window and the preamble sent to the base station at the preamble transmission opportunity within the next preset time window are identical.

8. The method of claim 1, wherein the preamble sent to the base station at the preamble transmission opportunity within the preset time window and the preamble sent to the base station at the preamble transmission opportunity within the next preset time window are different preambles in a set of preambles.

9. A random access control method, comprising:
sending a preamble to a base station at a preamble transmission opportunity within a preset time window, wherein the preset time window comprises multiple preamble transmission opportunities;
determining whether a random access response (RAR) is received from the base station;
when the RAR is not received from the base station, determining whether a first count value is equal to a first preset value;
when the first count value is not equal to the first preset value, determining whether a time window monitoring reception of the RAR and corresponding to the preset time window ends;
when the time window monitoring reception of the RAR and corresponding to the preset time window ends, sending the preamble to the base station at a preamble transmission opportunity within a next preset time window, and increasing the first count value;
when the time window monitoring reception of the RAR and corresponding to the preset time window does not end, sending the preamble to the base station at a next preamble transmission opportunity, and increasing the first count value;
repeating above steps; and until the first count value is equal to the first preset value or the RAR is received from the base station, stopping sending the preamble to the base station.

10. The method of claim 9, wherein the first count value is a count value of a preamble transmission counter.

11. An electronic device, comprising:
a processor; and
a memory configured to store instructions executable by the processor,
wherein the processor is configured to:
send a preamble to a base station at a preamble transmission opportunity within a preset time window and increase a first count value, wherein the preset time window comprises multiple preamble transmission opportunities;
determine whether a random access response (RAR) is received from the base station;
when the RAR is not received from the base station, determine whether the first count value is equal to a first preset value;
when the first count value is not equal to the first preset value, determine whether a time window monitoring reception of the RAR and corresponding to the preset time window ends;
when the time window monitoring reception of the RAR and corresponding to the preset time window ends, send the preamble to the base station at a preamble transmission opportunity within a next preset time window and increase the first count value;
when the time window monitoring reception of the RAR and corresponding to the preset time window does not end, send the preamble to the base station at a next preamble transmission opportunity and increase the first count value;
repeat above steps; and, until the first count value is equal to the first preset value or the RAR is received from the base station, stop sending the preamble to the base station.

12. The electronic device of claim 11, wherein the processor is further configured to:
when the time window monitoring reception of the RAR ends, determine whether preamble transmission power needs to be adjusted; and
when the preamble transmission power needs to be adjusted, increase a second count value, and adjust the preamble transmission power for sending the preamble to the base station within the next preset time window according to the second count value.

13. The electronic device of claim 11, wherein the processor is further configured to:
determine whether preamble transmission power needs to be adjusted; and
when the preamble transmission power needs to be adjusted, increase a second count value when the first count value is increased, and adjust the preamble transmission power for sending the preamble to the base station at the next preamble transmission opportunity according to the second count value.

14. The electronic device of claim 13, wherein the processor is further configured to:
determine whether to change a beam for sending a next preamble; and
when it is determined to change the beam for sending the next preamble, determine that the preamble transmission power needs to be adjusted.

15. The electronic device of claim 13, wherein the processor is further configured to:
determine whether the second count value is equal to a second preset value; and
when the second count value is not equal to the second preset value, determine that the preamble transmission power needs to be adjusted.

16. The electronic device of claim 11, wherein the processor is further configured to perform one of:
sending the preamble at a first preamble transmission opportunity within each preset time window through first beams of different directions; or
sending the preamble at each preamble transmission opportunity within the preset time window through beams of a same direction.

17. The electronic device of claim 11, wherein the preamble sent to the base station at the preamble transmission opportunity within the preset time window and the preamble sent to the base station at the preamble transmission opportunity within the next preset time window are identical.

18. The electronic device of claim 11, wherein the preamble sent to the base station at the preamble transmission opportunity within the preset time window and the preamble sent to the base station at the preamble transmission opportunity within the next preset time window are different preambles in a set of preambles.

19. An electronic device, comprising:
a processor; and
a memory configured to store instructions executable by the processor,
wherein the processor is configured to perform the random access control method of claim 9.

20. The electronic device of claim 19, wherein the first count value is a count value of a preamble transmission counter.
